(19) United States
(12) Patent Application Publication
(10) Pub. No.: US 2026/0307796 A1
(43) Pub. Date: Oct. 8, 2026

(54) Monument Sliding Rail System with Height Adjust

(71) Applicant: B/E Aerospace, Inc., Winston Salem, NC (US)

(72) Inventors: Spencer D. Martin, High Point, NC (US); Michael Boyd, Walkertown, NC (US); Patrick Michael Quinn, Winston-Salem, NC (US)

(73) Assignee: B/E Aerospace, Inc., Winston Salem, NC (US)

(21) Appl. No.: 19/636,671

(22) Filed: Apr. 1, 2026

Related U.S. Application Data
(60) Provisional application No. 63/783,796, filed on Apr. 4, 2025.
(60) Provisional application No. 63/783,442, filed on Apr. 4, 2025.

(51) Int. Cl. B64D 11/04; B61B 5/02

(52) U.S. Cl. CPC B64D 11/04; B61B 5/02

(57) ABSTRACT

A panel attachment system may couple a translating wall to a rail system. The panel attachment system may be configured to facilitate longitudinal adjustment and vertical adjustment of the translating wall with respect to the rail system. The panel attachment system may comprise a pair of first blocks coupled by a bridge. Each first block may be coupled to a second block. The second block may have rollers for longitudinal translation of the panel attachment system with respect to the rail system. Each first block may be coupled to a third block. The third block may have a hanging bracket for receiving the translating wall. The third block may be adjustable with respect to the first block for vertical adjustment of the panel attachment system with respect to the rail system.

### CROSS REFERENCE TO RELATED APPLICATIONS

This application claims the benefit of and priority to U.S. Provisional Application Number 63/783,796, entitled “MONUMENT DEPLOYABLE WORK SURFACE,” filed on Apr. 4, 2025, and U.S. Provisional Application Number 63/783,442, entitled “MONUMENT SLIDING RAIL SYSTEM WITH HEIGHT ADJUST,” filed on Apr. 4, 2025, which are both hereby incorporated by reference in their entirety for all purposes.

### TECHNICAL FIELD

The present disclosure relates generally to a rail system and, more particularly, to an aircraft monument rail system.

### BACKGROUND

Various structures may be attached to rail systems for installation within aircraft cabins. For example, storage compartments, seats, monuments, etc. may be coupled to an aircraft cabin floor. Sliding rail systems may provide for stable structures capable of supporting significant loads in flight while also providing for ease of installation and removal during, for example, maintenance operations. Conventional attachment mechanisms are disposed above the rail system in positions that are difficult to access or lead to rocking and unstable conditions. Conventional attachment mechanisms are difficult and time-consuming to adjust.

### SUMMARY

A panel attachment system is disclosed. The panel attachment system may comprise a pair of first blocks each coupled to a bridge; a pair of hanging brackets coupled to and extending from the pair of first blocks in a vertical direction; and a plurality of rollers coupled to the pair of first blocks in a longitudinal direction.

In various embodiments, the pair of third blocks may define a pair of hanging brackets having a longitudinal bracket midline, and the pair of first blocks may have a longitudinal block midline. In various embodiments, the longitudinal bracket midline is spaced from the longitudinal block midline.

In various embodiments, a height of the hanging bracket may be adjustable with respect to the pair of first blocks.

In various embodiments, the bridge may bracket the pair of first blocks between a pair of vertical flanges.

In various embodiments, each first block may be disposed between a corresponding set of rollers of the plurality of rollers and a corresponding vertical flange of the bridge.

In various embodiments, each hanging bracket may be coupled to one of the first blocks of the pair of first blocks via a fastener having a threaded shank and a head.

In various embodiments, the head of each adjustment fastener may be disposed on an opposing side of the pair of first blocks from the bridge.

A panel attachment system is disclosed. The panel attachment system may comprise a first block having an inverted L-shaped cross-section and a first through-hole; a second block having a plurality of rollers and coupled to the first block; and a third block having a T-shaped cross-section, a hanging bracket extending in a vertical direction, and a second through-hole, wherein the first through-hole of the first block and the second through-hole of the third block are aligned and configured to receive an adjustment fastener.

In various embodiments, the third block may comprise a long flange and a short flange extending in opposing longitudinal directions from the vertical stem. In various embodiments, the long flange may have a length in the longitudinal direction that is greater than a length of the short flange in the longitudinal direction.

In various embodiments, the first through-hole and the second through-hole may be disposed in the vertical direction.

In various embodiments, the first block may have a third through-hole, the second block has a fourth through-hole, and the third block has a fifth through-hole. In various embodiments, the third through-hole, the fourth through-hole, and the fifth through-hole may be disposed in a lateral direction and aligned such that the third through-hole, the fourth through-hole, and the fifth through-hole are configured to receive a common fastener.

In various embodiments, the fifth through-hole may have a greater diameter than the fourth through-hole such that the common fastener may pass through the third block.

In various embodiments, the hanging bracket may have a sixth through-hole disposed in a longitudinal direction.

In various embodiments, the first block may have disposed laterally between the plurality of rollers and the third block.

In various embodiments, a rail system is disclosed. The rail system may comprise a ceiling panel with a pair of elongated slots extending in a longitudinal direction; a pair of rails extending vertically from the ceiling panel in a first direction and disposed along the ceiling panel in the longitudinal direction, each rail of the pair of rails having an outward facing track; and a panel attachment system longitudinally translatable with respect to the pair of rails and accessible from a second direction vertically opposing the first direction.

In various embodiments, the panel attachment system may comprise an adjustment fastener; a first block having a first through-hole; a second block having a plurality of rollers configured to translate within the outward facing tracks, the second block coupled to the first block; and a third block having a hanging bracket extending in a vertical direction and a second through-hole aligned with the first through-hole, wherein each of the first block and the third block is configured to receive the adjustment fastener through each of the first through-hole and the second through-hole.

In various embodiments, the adjustment fastener may be adjustable through the pair of elongated slots.

In various embodiments, the third block may have a long flange and a short flange each extending perpendicular from the hanging bracket in opposing directions. In various embodiments, the long flange may have a greater length than the short flange in the longitudinal direction.

In various embodiments, the hanging bracket may have a longitudinal bracket midline, and the first block may have a longitudinal block midline. In various embodiments, the longitudinal bracket midline may be spaced from the longitudinal block midline.

In various embodiments, the hanging bracket may have a third through-hole extending in the longitudinal direction.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft, in accordance with various embodiments;

FIG. 2 illustrates an aircraft floorplan, in accordance with various embodiments;

FIG. 3 illustrates an aircraft monument in a stowed position, in accordance with various embodiments;

FIG. 4 illustrates an aircraft monument, in accordance with various embodiments;

FIG. 5 illustrates an aircraft monument in a deployed position, in accordance with various embodiments;

FIG. 6 illustrates a translatable door, in accordance with various embodiments;

FIG. 7 illustrates an exploded view of a rail system, in accordance with various embodiments;

FIG. 8 illustrates a perspective view of a rail system, in accordance with various embodiments;

FIG. 9 illustrates a side view of a panel attachment system, in accordance with various embodiments; and

FIG. 10 illustrates a perspective view of a panel attachment system, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to “singular” includes plural embodiments, and any reference to “more than one” component or step may include a singular embodiment or step. Also, any reference to “attached,” “fixed,” “connected,” or the like may include permanent, removable, temporary, partial, full, or any other possible attachment option. Additionally, any reference to “without contact” (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values, and all ranges and ratio limits disclosed herein may be combined.

As used herein, “aft” refers to the direction associated with the tail (e.g., the back end) of an aircraft, or generally, to the direction of exhaust of the gas turbine. As used herein, “forward” refers to the direction associated with the nose (e.g., the front end) of an aircraft, or generally, to the direction of flight or motion. As used herein, “rear” refers to the direction of the fuselage wall (e.g., away from an aisle). As used herein, “front” refers to the direction facing the aircraft aisle (e.g., opposite the fuselage wall). As used herein, “vertical” or “vertically” refers to the Z-direction. As used herein, “lateral” or “laterally” refers to the Y-direction. As used herein, “longitudinal” or “longitudinally” refers to the X-direction.

Various structures may be attached to rail systems for installation within aircraft cabins. For example, storage compartments, seats, monuments, etc., may be coupled to an aircraft cabin floor via rail systems. Sliding rail systems may couple various elements within monuments or other cabin structures to be translated within the monument or cabin structure. Sliding rail systems may couple panels or doors to vertical or overhead structures. The coupling mechanism for such structures may provide for stable structures capable of supporting significant loads in flight while also providing for ease of installation and removal during, for example, maintenance operations. However, conventional attachment mechanisms may be disposed above the rail systems in positions that are difficult to access. Conventional attachment mechanisms may increase the likelihood of rocking and/or unstable conditions. Conventional attachment mechanisms may be difficult and time-consuming to adjust.

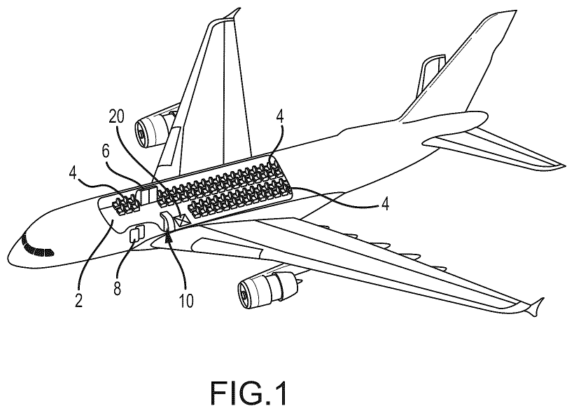

With initial reference to FIG. 1, an aircraft 1 is illustrated, in accordance with various embodiments. Aircraft 1 may comprise an aisle 2. Aircraft 1 may comprise a plurality of seats 4. Aircraft 1 may comprise one or more lavatories 6. Aircraft 1 may comprise a door 8. Aircraft 1 may comprise a monument 10. Aircraft 1 may comprise a wheelchair plinth 20. Wheelchair plinth 20 may be disposed proximate door 8. Wheelchair plinth 20 may be disposed proximate monument 10. Monument 10 may be disposed proximate passenger seating disposed immediately aft of an open space. In the event that wheelchair plinth 20 is unoccupied, monument 10 may be expanded as described further herein to provide an alternate workstation in aircraft 1.

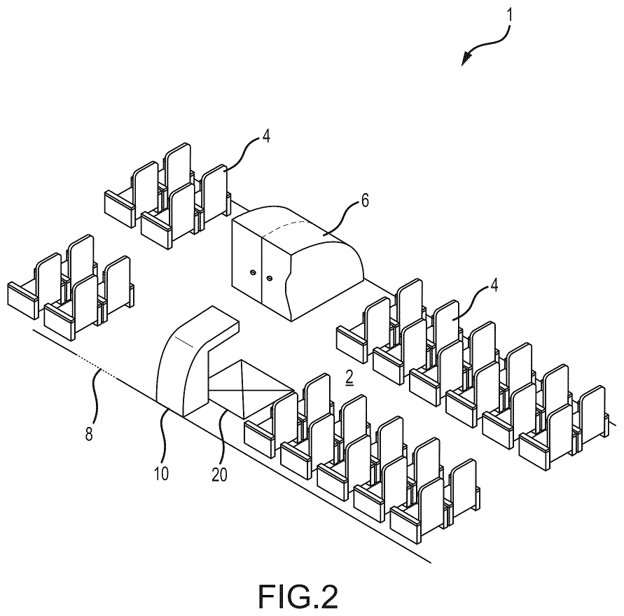

With reference to FIG. 2, a floor plan of aircraft 1 is illustrated, in accordance with various embodiments. As illustrated, wheelchair plinth 20 and monument 10 are disposed aft of door 8. However, it should be understood that wheelchair plinth 20 and/or monument 10 may be disposed at any location within aircraft 1. As illustrated, monument 10 is disposed outboard of wheelchair plinth 20 and faces inboard toward aisle 2. However, it should be understood that monument 10 may be disposed inboard of wheelchair plinth 20 and face outboard toward wheelchair plinth 20. While described as proximate wheelchair plinth 20, it should be understood that the monument may instead be disposed proximate an open space in aircraft 1 or proximate passenger seating disposed immediately aft of an open space.

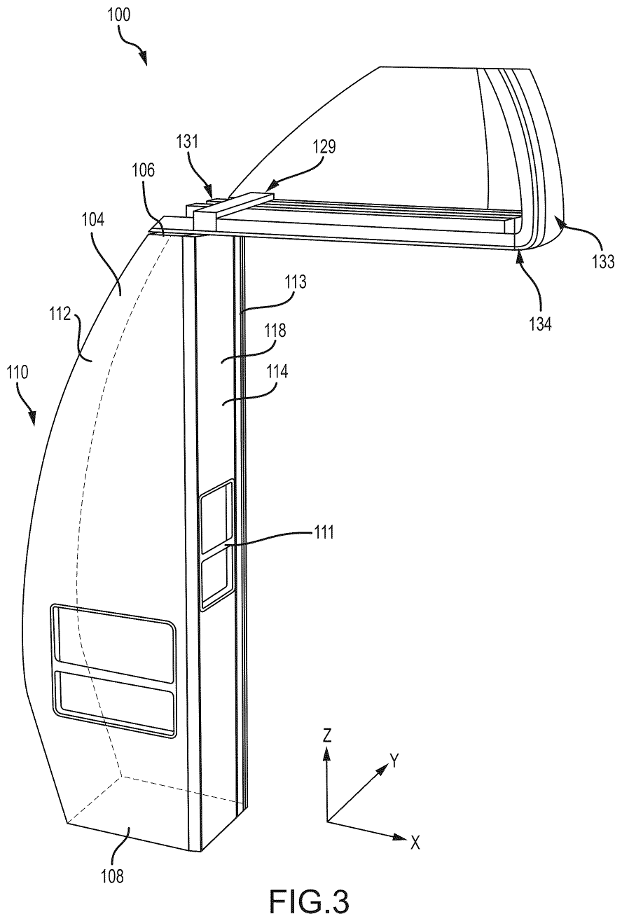

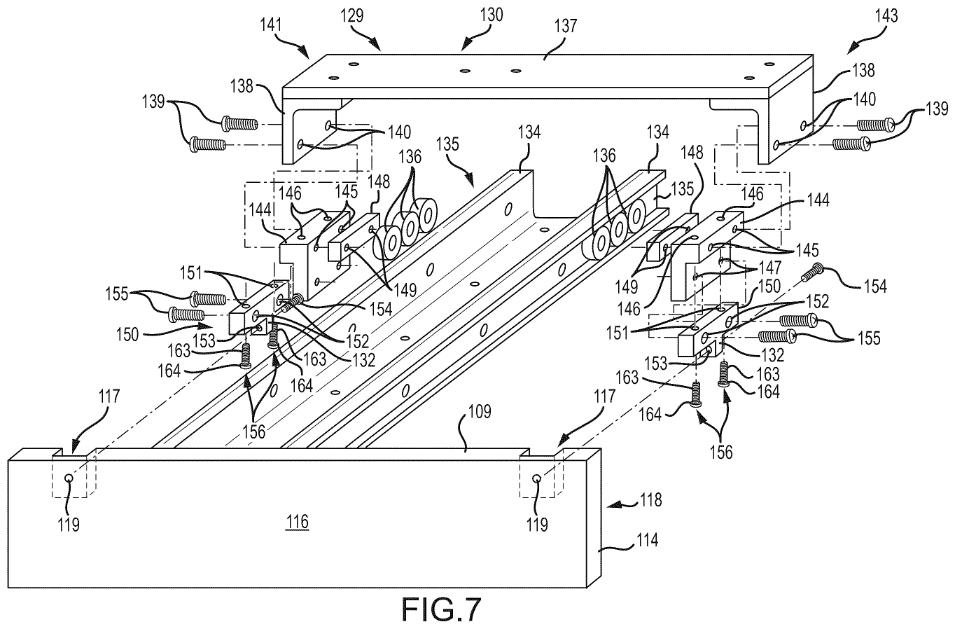

With reference to FIGS. 3-5, a monument system 100 is illustrated, in accordance with various embodiments. Monument system 100 may comprise a monument 110 similar to monument 10. In various embodiments, monument 110 comprises a ceiling 106 and a floor 108. In various embodiments, monument 110 comprises a first sidewall 112 and a second sidewall 113. Monument 110 may comprise a translating wall 114. Monument 110 may comprise a rear wall 104 opposing translating wall 114. Rear wall 104 may be dimensioned to fit against an outboard wall of aircraft 1. Translating wall 114 may be translatable with respect to first sidewall 112 and second sidewall 113. In various embodiments, translating wall 114 comprises a handle 111 for translating wall 114 with respect to first sidewall 112 and second sidewall 113. Handle 111 may be disposed on an outer face 118 of translating wall 114. As best illustrated in FIG. 7, translating wall 114 may comprise an inner face 116 opposing outer face 118.

Monument system 100 may comprise a workstation 120. Workstation 120 may be deployable from monument 110. Workstation 120 may be stored within monument 110.

Monument system 100 may comprise a rail system 130 for controlling the translation of translating wall 114. Rail system 130 may be disposed proximate a bin space of aircraft 1. Rail system 130 may be adjustable from a position beneath rail system 130. Rail system 130 may be configured to translate translating wall 114. Rail system 130 may allow for an adjustment of translating wall 114 in a longitudinal direction. Rail system 130 may allow for an adjustment of translating wall 114 in a vertical direction. Rail system 130 may allow for an adjustment of translating wall 114 in both a vertical direction and a longitudinal direction.

With reference to FIG. 3, monument 110 is illustrated in a stowed position in which translating wall 114 is disposed against first sidewall 112 and second sidewall 113 at a first longitudinal position. Translating wall 114 is coupled to rail system 130 at a first end 131 of rail system 130.

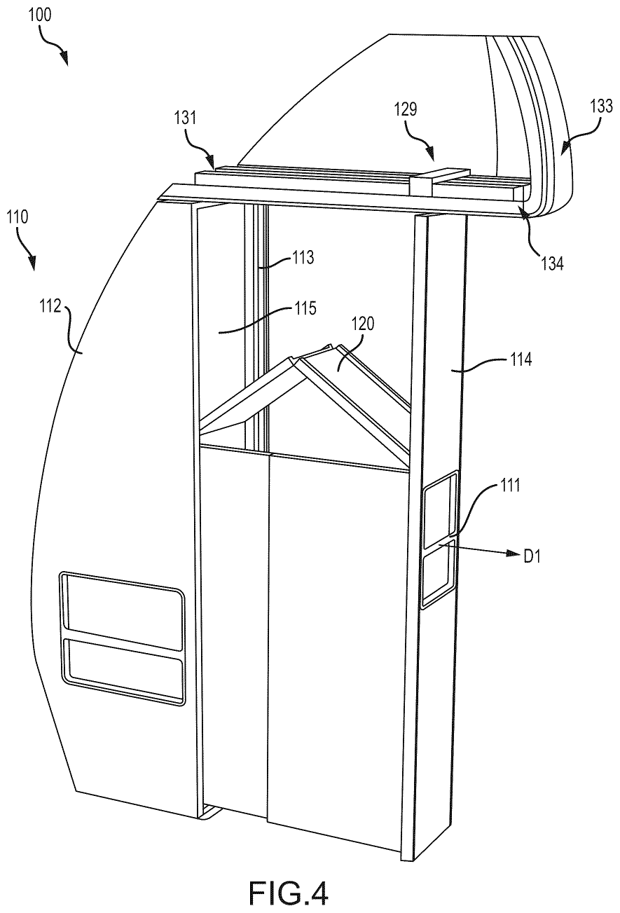

With reference to FIG. 4, monument 110 is illustrated as translating from the stowed position to a deployed position. In response to a pulling force applied to handle 111 in a first direction D1, translating wall 114 may be translated away from first sidewall 112 and second sidewall 113. It should be understood that, similarly, in response to a pushing force applied to handle 111 in a direction opposite of first direction D1, translating wall 114 may be translated toward first sidewall 112 and second sidewall 113 (from the deployed position to the stowed position). In response to monument 110 translating from the stowed position to the deployed position, workstation 120 may be deployed from a storage space 115 disposed between first sidewall 112 and second sidewall 113. As translating wall 114 translates in first direction D1, translating wall 114 translates within rail system 130. As translating wall 114 translates in first direction D1, a position of translating wall 114 is guided by rail system 130.

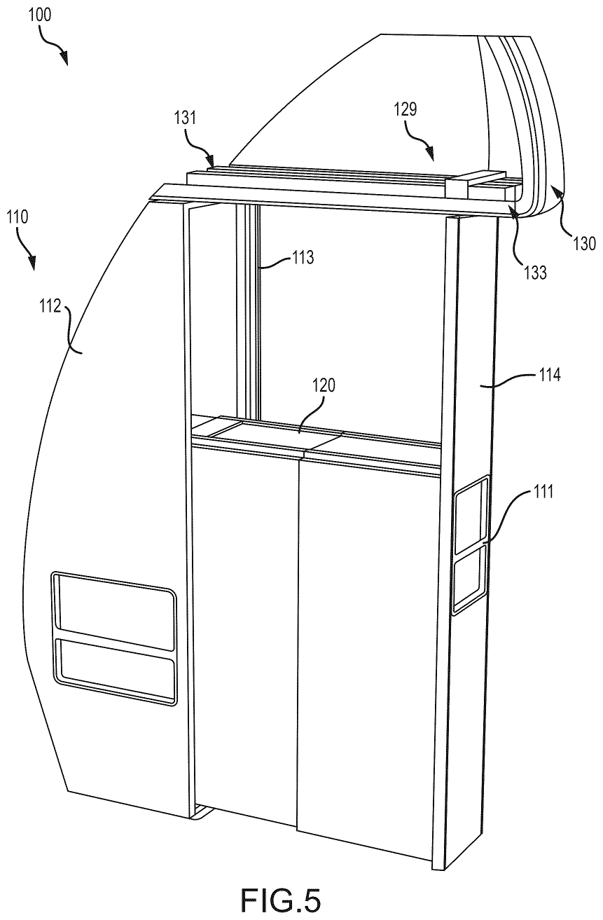

With reference to FIG. 5, monument 110 is illustrated in a deployed position in which translating wall 114 is spaced from first sidewall 112 and second sidewall 113. In the deployed position, translating wall 114 is at a second longitudinal position. The second longitudinal position may be spaced from first sidewall 112 and second sidewall 113. The second longitudinal position may be proximate a second end 133 of rail system 130. In the deployed position, workstation 120 may be fully extended.

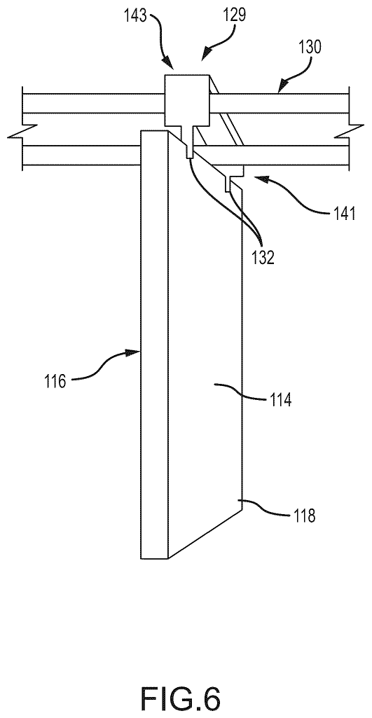

With reference to FIG. 6, translating wall 114 is illustrated as hanging from rail system 130. Translating wall 114 may be coupled to rail system 130 via a panel attachment system 129. Panel attachment system 129 may comprise hanging brackets 132. Hanging brackets 132 may extend from either side of panel attachment system 129. Translating wall 114 may be coupled to rail system 130 via hanging brackets 132 of panel attachment system 129. Panel attachment system 129 may be configured as an anti-rack device to prevent racking or tilting of translating wall 114 during translation. Panel attachment system 129 may extend from a first side 141 of rail system 130 to a second side 143 of rail system 130. Panel attachment system 129 may allow for an adjustment of translating wall 114 in a longitudinal direction. Panel attachment system 129 may allow for an adjustment of translating wall 114 in a vertical direction. Panel attachment system 129 may allow for an adjustment of translating wall 114 in both a vertical direction and a longitudinal direction.

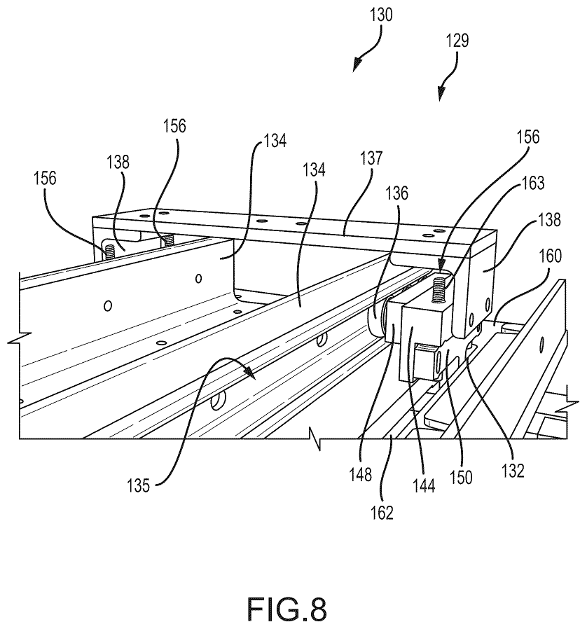

With reference to FIG. 8, rail system 130 may comprise a ceiling panel 160. Ceiling panel 160 may have a pair of elongated slots 162 extending in a longitudinal direction. Elongated slots 162 may provide access to structures located above ceiling panel 160. Elongated slots 162 may provide access to various portions of panel attachment system 129 such that panel attachment system 129 may be adjusted from a position beneath ceiling panel 160.

With reference to FIGS. 7 and 8, and in various embodiments, rail system 130 may comprise a pair of rails 134. Each rail 134 may extend vertically from ceiling panel 160. Each rail 134 may extend longitudinally along ceiling panel 160. Each rail 134 may be disposed on one of first side 141 or second side 143 of rail system 130. Each rail 134 may be disposed laterally between the pair of elongated slots 162. Each rail 134 may comprise a track 135 extending in a longitudinal direction. Tracks 135 may be outward-facing tracks. Rails 134 may be configured to guide a longitudinal position of translating wall 114.

In various embodiments, panel attachment system 129 may comprise a bridge 137. Bridge 137 may be a bracket extending across both rails 134 of the pair. Bridge 137 may have vertical flanges 138 extending on each outer side of the pair of rails 134. Each vertical flange 138 may have one or more first through-holes 140 for receiving a fastener 139. Fastener 139 may be a screw, bolt, stud, rivet, pin, clip, snap-fit feature, or other suitable securing member. Each first through-hole 140 may extend in a lateral direction through a vertical flange 138.

In various embodiments, panel attachment system 129 may comprise a pair of first blocks 144. First blocks 144 may have an inverted L-shaped cross-section. Each first block 144 may be configured to couple to a vertical flange 138. Each first block 144 may be configured to couple to a second block 148, described below. Each first block 144 may be configured to couple to a third block 150, described below. Each first block 144 may have one or more second through-holes 145. Each second through-hole 145 may extend in a lateral direction through a first block 144. Each second through-hole 145 may be configured to align with a first through-hole 140. Each first block 144 may be configured to receive a fastener 139 through each second through-hole 145. In this manner, each first block 144 may be coupled to a vertical flange 138. Each first block 144 may comprise one or more third through-holes 146. Each third through-hole 146 may extend in a vertical direction through a first block 144. Each third through-hole 146 may be configured to receive an adjustment fastener 156, described further below. Each first block 144 may comprise one or more fourth through-holes 147. Each fourth through-hole 147 may extend in a lateral direction through a first block 144. Each fourth through-hole 147 may be configured to receive a fastener 155. Fastener 155 may be a screw, bolt, stud, rivet, pin, clip, snap-fit feature, or other suitable securing member.

In various embodiments, panel attachment system 129 may comprise a pair of second blocks 148. Each second block 148 may be a rectangular prism. Each second block 148 may be a longitudinal block. Each second block 148 may be configured to couple to a first block 144. Each second block 148 may be configured to couple to one or more rollers 136, described further below. Each second block 148 may have one or more fifth through-holes 149. Each fifth through-hole 149 may extend in a lateral direction through a second block 148. Each fifth through-hole 149 may be configured to align with a second through-hole 145. Each second block 148 may be configured to receive a fastener 139 through each fifth through-hole 149. In this manner, each second block 148 may be coupled to a first block 144.

In various embodiments, panel attachment system 129 may comprise rollers 136. Each roller 136 may be coupled to a second block 148. Panel attachment system 129 may comprise a plurality of rollers 136 coupled to each second block 148. Each track 135 may be configured to receive rollers 136 therein to facilitate longitudinal translation of translating wall 114. Rollers 136 may be inboard facing toward tracks 135 and away from vertical flanges 138 of bridge 137. In other words, rollers 136 may be disposed between tracks 135 and vertical flanges 138 of bridge 137.

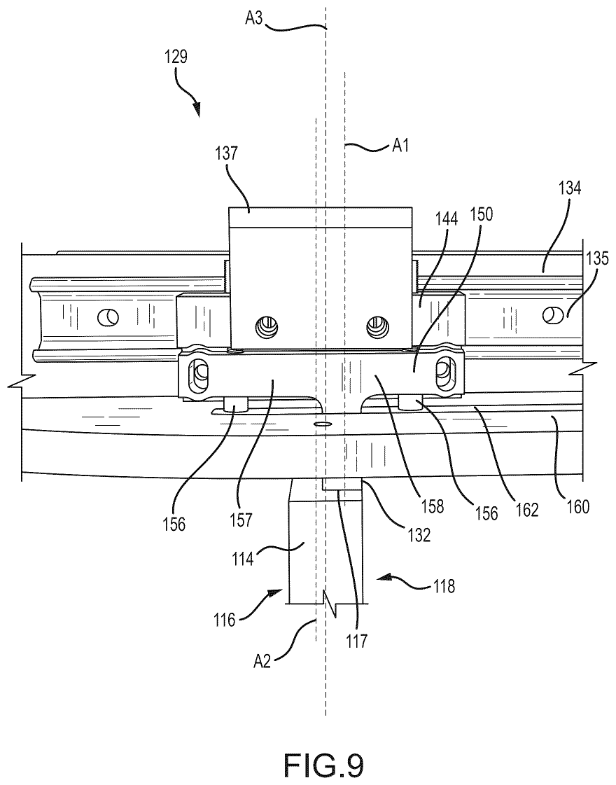

In various embodiments, panel attachment system 129 may comprise a third block 150. Third block 150 may have a T-shaped cross-section. Each third block 150 may comprise a hanging bracket 132. With brief additional reference to FIG. 9, each third block 150 may comprise a long flange 157 and a short flange 158 extending from opposing sides of hanging bracket 132. Each third block 150 may be configured to couple to a first block 144. Each third block 150 may be configured to couple to translating wall 114. Each third block 150 may have one or more sixth through-holes 151. Each sixth through-hole 151 may extend in a vertical direction through a third block 150. Each sixth through-hole 151 may be configured to align with a third through-hole 146. Each third block 150 may be configured to receive an adjustment fastener 156, described further below, through each sixth through-hole 151. In this manner, each third block 150 may be coupled to a first block 144. Each third block 150 may have one or more seventh through-holes 152. Each seventh through-hole 152 may extend in a lateral direction through a third block 150. Each seventh through-hole 152 may be configured to align with a fourth through-hole 147. Each third block 150 may be configured to receive a fastener 155 through each seventh through-hole 152. Each seventh through-hole 152 may have a diameter larger than each fourth through-hole 147 such that fastener 155 may pass through third block 150. In this manner, each second block 148 may be coupled to a first block 144 without fixing a vertical position of a third block 150. Each third block 150 may comprise an eighth through-hole 153. Each eighth through-hole 153 may extend in a longitudinal direction through a hanging bracket 132. Each hanging bracket 132 may be configured to receive a fastener 154. Fastener 154 may be a screw, bolt, stud, rivet, pin, clip, snap-fit feature, or other suitable securing member.

In various embodiments, translating wall 114 may comprise one or more ninth through-holes 119. Each ninth through-hole 119 may extend in a longitudinal direction at least partially into at least one of outer face 118 or inner face 116 of translating wall 114. For example, and as illustrated, each ninth through-hole 119 may extend in a longitudinal direction at least partially into outer face 118 of translating wall 114. Each ninth through-hole 119 may be configured to receive a fastener 154. In this manner, each third block 150 may be coupled to translating wall 114 via a hanging bracket 132.

In various embodiments, translating wall 114 may comprise a recess 117. Translating wall 114 may comprise a pair of recesses 117. Each recess 117 may be disposed into outer face 118 and a top surface 109 of translating wall 114. However, the disclosure is not limited in this regard. For example, each recess 117 may be disposed into inner face 116 of translating wall 114. Each recess 117 may be disposed into top surface 109 of translating wall 114 while each of inner face 116 and outer face 118 are flat surfaces. In various embodiments, each recess 117 comprises a ninth through-hole 119. In various embodiments, each recess 117 may be configured to receive a hanging bracket 132 such that each hanging bracket 132 extends at least partially into a perimeter of translating wall 114.

With reference to FIG. 9, panel attachment system 129 is illustrated in a side view. In various embodiments, third block 150 is asymmetric. In various embodiments, long flange 157 has a greater length (measured in the longitudinal direction) than short flange 158. As such, a longitudinal bracket midline A1 of hanging bracket 132 is longitudinally spaced from a longitudinal block midline A2 of third block 150. In various embodiments, longitudinal block midline A2 may also be aligned to a longitudinal midline of bridge 137. In various embodiments, longitudinal block midline A2 may also be aligned to a longitudinal midline of first block 144. In various embodiments, longitudinal block midline A2 may also be aligned to a longitudinal midline of second block 148. In various embodiments, translating wall 114 has a longitudinal wall midline A3. In various embodiments, longitudinal wall midline A3 is longitudinally spaced from longitudinal bracket midline A1. In various embodiments, longitudinal wall midline A3 is longitudinally spaced from longitudinal block midline A2. However, the disclosure is not limited in this regard. In various embodiments, longitudinal wall midline A3 may be aligned to longitudinal block midline A2.

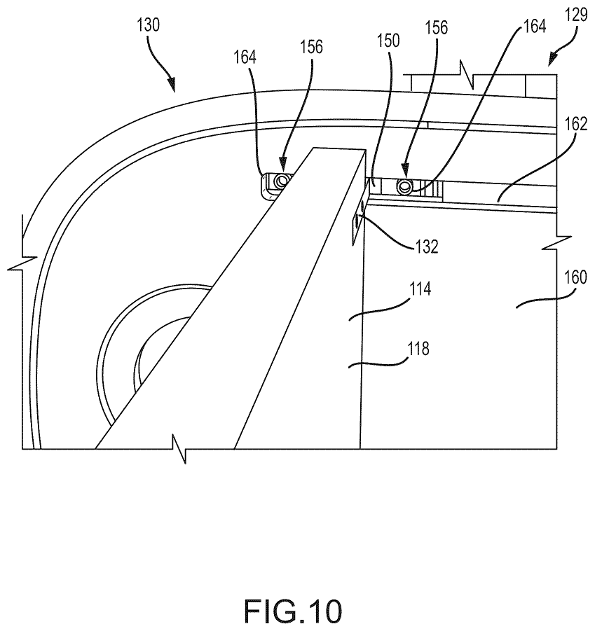

With additional reference to FIG. 10, and in various embodiments, hanging bracket 132 may extend through an elongated slot 162 of ceiling panel 160 to translating wall 114. Each adjustment fastener 156 may be accessible from an underside of ceiling panel 160 through elongated slot 162. Adjustment fasteners 156 may be accessible through elongated slot 162 for adjusting a vertical position of translating wall 114. In various embodiments, adjustment fastener 156 may be a screw, bolt, stud, rivet, pin, clip, snap-fit feature, or other functionally equivalent securing member. Each adjustment fastener 156 may comprise a shank 163 extending along a vertical axis and a head 164 at a bottom end of shank 163. Shank 163 may extend through each of first block 144 and third block 150. Head 164 may extend from a bottom side of third block 150 toward translating wall 114. Shank 163 may provide for adjustments of a height of translating wall 114. For example, shank 163 may be a threaded shank such that shank 163 provides for continuous adjustments of a height of translating wall 114.

Finally, it should be noted that while this disclosure is directed primarily to panel attachment system 129 for attaching translating wall 114 to rail system 130, the concepts described above can also be applied to panel attachment systems for coupling any panel structure to any rail system. For example, panel attachment system 129 may couple a lavatory wall, a door, a galley structure, or any other structure to an overhead rail system. Further, panel attachment system 129 and rail system 130 may be rotated to attach a structure such as a seat to an underfoot rail system.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the specification or claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A panel attachment system, comprising:
a pair of first blocks each coupled to a bridge;
a pair of hanging brackets coupled to and extending from the pair of first blocks in a vertical direction; and
a plurality of rollers coupled to the pair of first blocks in a longitudinal direction.

2. The panel attachment system of claim 1, wherein the pair of third blocks defines a pair of hanging brackets having a longitudinal bracket midline, and the pair of first blocks has a longitudinal block midline, wherein the longitudinal bracket midline is spaced from the longitudinal block midline.

3. The panel attachment system of claim 1, wherein a height of the hanging bracket is adjustable with respect to the pair of first blocks.

4. The panel attachment system of claim 1, wherein the bridge brackets the pair of first blocks between a pair of vertical flanges.

5. The panel attachment system of claim 4, wherein each first block is disposed between a corresponding set of rollers of the plurality of rollers and a corresponding vertical flange of the bridge.

6. The panel attachment system of claim 1, wherein each hanging bracket is coupled to one of the first blocks of the pair of first blocks via a fastener having a threaded shank and a head.

7. The panel attachment system of claim 6, wherein the head of each adjustment fastener is disposed on an opposing side of the pair of first blocks from the bridge.

8. A panel attachment system, comprising:
a first block having an inverted L-shaped cross-section and a first through-hole;
a second block having a plurality of rollers and coupled to the first block; and
a third block having a T-shaped cross-section, a hanging bracket extending in a vertical direction, and a second through-hole, wherein the first through-hole of the first block and the second through-hole of the third block are aligned and configured to receive an adjustment fastener.

9. The panel attachment system of claim 8, wherein the third block comprises a long flange and a short flange extending in opposing longitudinal directions from the vertical stem, the long flange having a length in the longitudinal direction that is greater than a length of the short flange in the longitudinal direction.

10. The panel attachment system of claim 8, wherein the first through-hole and the second through-hole are disposed in the vertical direction.

11. The panel attachment system of claim 10, wherein the first block has a third through-hole, the second block has a fourth through-hole, and the third block has a fifth through-hole, wherein the third through-hole, the fourth through-hole, and the fifth through-hole are disposed in a lateral direction and aligned such that the third through-hole, the fourth through-hole, and the fifth through-hole are configured to receive a common fastener.

12. The panel attachment system of claim 11, wherein the fifth through-hole has a greater diameter than the fourth through-hole such that the common fastener may pass through the third block.

13. The panel attachment system of claim 11, wherein the hanging bracket has a sixth through-hole disposed in a longitudinal direction.

14. The panel attachment system of claim 8, wherein the first block is disposed laterally between the plurality of rollers and the third block.

15. A rail system, comprising:
a ceiling panel with a pair of elongated slots extending in a longitudinal direction;
a pair of rails extending vertically from the ceiling panel in a first direction and disposed along the ceiling panel in the longitudinal direction, each rail of the pair of rails having an outward facing track; and
a panel attachment system longitudinally translatable with respect to the pair of rails and accessible from a second direction vertically opposing the first direction.

16. The rail system of claim 15, wherein the panel attachment system comprises:
an adjustment fastener;
a first block having a first through-hole;
a second block having a plurality of rollers configured to translate within the outward facing tracks, the second block coupled to the first block; and
a third block having a hanging bracket extending in a vertical direction and a second through-hole aligned with the first through-hole, wherein each of the first block and the third block is configured to receive the adjustment fastener through each of the first through-hole and the second through-hole.

17. The rail system of claim 16, wherein the adjustment fastener is adjustable through the pair of elongated slots.

18. The rail system of claim 16, wherein the third block has a long flange and a short flange each extending perpendicular from the hanging bracket in opposing directions, the long flange having a greater length than the short flange in the longitudinal direction.

19. The rail system of claim 18, wherein the hanging bracket has a longitudinal bracket midline, and the first block has a longitudinal block midline, wherein the longitudinal bracket midline is spaced from the longitudinal block midline.

20. The rail system of claim 16, wherein the hanging bracket has a third through-hole extending in the longitudinal direction.
